(19) United States
(12) Patent Application Publication
(10) Pub. No.: US 2021/0114836 A1
(43) Pub. Date: Apr. 22, 2021

(54) APPLICATOR FOR PLASMA-INITIATED ADHESIVE STRIPS, COMPRISING A FOLDING MECHANISM

(71) Applicant: tesa SE, Norderstedt (DE)

(72) Inventor: Marcel HÄHNEL, Klein Nordende (DE)

(21) Appl. No.: 16/464,466

(22) PCT Filed: Nov. 28, 2017
(86) PCT No.: PCT/EP2017/080599

§ 371 Date: May 28, 2019

(30) Foreign Application Priority Data
Nov. 30, 2016 (DE) 10 2016 223 783.7

(51) Int. Cl. B65H 35/00; B65H 37/06; C09J 7/10; C09J 5/04

(52) U.S. Cl. CPC B65H 35/0026; B65H 37/06; C09J 7/10; C09J 2301/208; B65H 2701/11332; B65H 2801/51; C09J 2301/416; C09J 5/04

(57) ABSTRACT

The invention relates to an applicator for a folded adhesive tape (8) comprising an adhesive tape roll (6) with an adhesive tape (7) which comprises a bonding agent layer (30), an unwinding device for an end section of the adhesive tape (7) from the adhesive tape roll (6), a plasma source (20) having a process gas (22) enriched with reactive species, directed onto a reactive outer side (31) of the bonding agent layer (30) of the unwound end section of the adhesive tape (7), wherein the bonding agent layer (30) at least one substance folding device (10) for the adhesive tape (7), disposed downstream of the plasma source (20) in a running direction of the adhesive tape (7), for producing the folded adhesive tape (8).

### TECHNICAL FIELD

The invention relates to an applicator for an adhesive tape and also to a method for producing a folded adhesive tape from an adhesive tape.

### BACKGROUND

Adhesive tapes are of course well known in the prior art. In certain industrial applications, as for example in the automotive sector, joints are also required to be able to bridge spacings between adherends of several millimetres. For many applications, moreover, 2-component adhesive systems are required. According to the prior art, however, it is difficult to provide products of such high-build form, and so varying joints of several millimetres must normally be bridged by applying adhesive tapes in a plurality of plies.

Joints varying in width have to date been fillable completely and with virtually no air inclusions only by means of adhesives in the form of adhesive beads. Only this ensures an optimum bond between the adherends. Depending on the viscosity and the geometric circumstances, there may in such cases be instances of severe oozing or running of the adhesives, meaning that they cannot be applied in every situation and that specific techniques are required, since otherwise there would be fouling of sensitive areas.

In the case of systems with 2 or more components, it is necessary to ensure sufficient mixing and/or precise application rates of the individual components.

It is an object of the invention, therefore, to provide an applicator with plasma unit for a folded 1-component, plasma-initiatable adhesive tape, and also a method for producing a plasma-initiatable, folded adhesive tape.

### SUMMARY

With regard to the apparatus, the object is met by an aforesaid applicator having the features of claim 1.

The invention combines on the one hand a method for activating bonding agent layers of an adhesive tape by means of plasma and on the other hand a subsequent and/or prior folding of the adhesive tape to form a folded and therefore thicker adhesive tape.

The applicator of the invention for a folded adhesive tape with a plasma-initiatable 1-component bonding system comprises an adhesive tape roll with an adhesive tape which comprises a film of adhesive with a reactive adhesive component and a reactive outer side, a feed device, a plasma source with a process gas enriched with reactive species, directed onto a reactive outer side of the bonding agent layer, wherein the bonding agent layer comprises at least one substance which triggers a crosslinking reaction, initiated by the reactive adhesive component on the reactive outer side of the film of adhesive of the unwound adhesive tape, to form an activated adhesive tape, and activates the bonding agent layer, and a folding device for the activated adhesive tape, disposed downstream of the feed device and plasma source in the running direction of the activated adhesive tape, for producing the folded adhesive tape.

### BRIEF DESCRIPTION OF THE DRAWINGS

The invention is described with reference to a working example in six figures, wherein

FIG. 1 shows a hand-guided applicator in a schematic interior view,

FIG. 2 shows plasma source with feed apparatus for defined process gas constituents,

FIG. 3 shows a sectional view of an adhesive tape as used in an applicator in FIG. 1,

FIGS. 4a to 4c show method steps in an uneven-numbered folding of the adhesive tape,

FIGS. 5a to 5c show method steps in an even-numbered folding of the adhesive tape,

FIGS. 6a, 6b show the folding mechanism.

### DETAILED DESCRIPTION

The invention relates to an applicator for an adhesive tape and also to a method for producing a folded adhesive tape from an adhesive tape.

An adhesive tape here means a flat structure having a longitudinal extent which is significantly, i.e., multiply, larger than a breadth and a height, where the breadth of the adhesive tape may also be greater significantly, i.e., by a multiple, than the height of the adhesive tape.

The adhesive tape may comprise a liner, which is a carrier layer which stabilizes the tape; however, it may also comprise two layers of liners, or even, optionally, even more liner layers. The liner consists preferably of siliconized polyester or siliconized paper, sometimes also siliconized or else unsiliconized polyolefin.

The film of adhesive of the adhesive tape may be of one-layer or multilayer configuration; here it is essential to the invention that the film of adhesive comprises or else is formed by the adhesive component, which initially is still unpolymerized, noncrosslinked or not completely crosslinked, but may well be pressure-sensitively adhesive, and the complete crosslinking of which, i.e., the through-curing/full curing, and the firm adhesive bonding thereof to an adherend surface, is generated only by the activation of the adhesive component by means of exposure to the plasma. Activation here means that a polymerization reaction is initiated in the adhesive. The polymerization reaction begins on the outer side of the adhesive layer on which the plasma first impinges, and continues into the adhesive layer. The polymerization reaction here is initiated in particular directly on the outer face and also, to a decreasing extent, at an increasing distance from the outer side, in the interior of the bonding agent layer.

The duration of the polymerization reaction is calculated such that the adhesive tape, after initiation of the polymerization reaction, can still be folded and hence the folded adhesive tape has a greater thickness than the adhesive tape, and the folded adhesive tape can then be applied to an adherend surface in order to serve for bridging large gaps between components for joining, and cures fully only after application to the adherend surface.

The chemical composition of the adhesive components and also of the reactive species added to the process gas for initiating the polymerization reaction in the adhesive layer are set out hereinafter.

The adhesive tape comprises an adhesive having a reactive adhesive component; the reactive adhesive component comprises a polymeric film-former matrix, at least one reactive monomer or reactive resin, and at least one initiator, more particularly radical initiator.

The film-former matrix comprises preferably a thermoplastic polymer from the group of a polyester or copolyester, a polyamide or copolyimide, a polyacrylic ester, an acrylic ester copolymer, a polymethacrylic ester, a methacrylic ester copolymer, thermoplastic polyurethanes, and also chemically or physically crosslinked species of the aforesaid compounds.

The activator is formed of an amine, a dihydropyridine derivative, a transition metal salt or a transition metal complex.

The initiator is formed by the reactive plasma components.

In one preferred embodiment, the folding device of the applicator comprises a stripping device for the liner or for a liner remnant, and the stripping device may consist of a plurality of individual stripping devices, which each strip a liner remnant from the adhesive tape and therefore different liner remnants can be removed successively from the adhesive tape. The folding device may likewise comprise a plurality of individual folding devices, so that it can be used to fold the adhesive tape multiply, singly, doubly or else in any desired higher number along a fold line running in the longitudinal direction. The individual folding devices and stripping devices may also be disposed in alternation. With preference the adhesive tape is first folded once, then a first liner remnant is stripped from the singly folded adhesive tape, the adhesive tape is optionally folded a second time, and a second liner remnant is stripped from the doubly folded adhesive tape; this process may in principle be repeated as often as desired.

In one particularly preferred embodiment of the invention, the applicator comprises a handle and the applicator is hand-guidable.

The film of adhesive preferably comprises at least one polymeric film-former matrix, at least one reactive monomer or reactive resin, at least one initiator, more particularly a radical initiator, while the further film of adhesive comprises a polymer film-former matrix, at least one reactive monomer or reactive resin, and at least one activator. The individual terms in the understanding used here are defined later on below.

With regard to the method, the object is achieved by a method having the features of claim 9.

The method is particularly suitable for implementation with one of the aforesaid applicators.

In accordance with the invention, preferably, an end section of an adhesive tape which comprises a film of adhesive having a reactive adhesive component and a reactive outer side is unwound from the adhesive tape roll and fed by means of a feeding device. The film of adhesive is activated by contact/treatment with a suitable plasma atmosphere. Following the activation of the film of adhesive, the adhesive tape is folded by means of a folding device. The adhesive tape is preferably folded at least once along a fold line which runs in the longitudinal direction. It may be folded once, twice or in any higher number, thereby allowing the thickness of the adhesive tape to be adapted to a desired mandated thickness. Between the individual folding steps, further plasma treatments may take place on one side or the other of the already partially folded adhesive tape. The thickness of the folded adhesive tape is preferably adapted to a gap width between two adherends. Naturally it is possible, as stated above, for a plurality of folds to be made as well, so that the folded adhesive tape has a thickness corresponding to an integral number of adhesive layers placed one above another. At each folding, the adhesive tape is folded along a fold line running in the longitudinal direction; after or before each folding operation, liner remnants can be stripped from the folded adhesive tape by means of a stripping device.

Film-Former Matrix

Suitable film-former matrices for use in the present invention are preferably selected from the following list: a thermoplastic polymer, such as, for example, a polyester or copolyester, polymer, a polyamide or copolyamide, a polyacrylic ester, an acrylic ester copolymer, polyurea, a polymethacrylic ester, a methacrylic ester copolymer, thermoplastic polyurethanes, and also chemically or physically crosslinked species of the compounds stated above. It is also possible, furthermore, to use blends of different thermoplastic polymers.

Also conceivable, moreover, are elastomers and thermoplastic elastomers on their own or in a mixture as polymeric film-former matrix. Thermoplastic polymers, especially those which are semicrystalline, are preferred.

Particularly preferred are thermoplastic polymers having softening temperatures of less than 100° C. In this context, the term “softening point” stands for the temperature above which the thermoplastic granules stick to themselves. Where the constituent of the polymeric film-former matrix is a semicrystalline thermoplastic polymer, it very preferably has not only its softening temperature (which is connected with the melting of the crystallites) but also a glass transition temperature of not more than 25° C., preferably not more than 0° C.

In one preferred embodiment in accordance with the invention, a thermoplastic polyurethane is used. The thermoplastic polyurethane preferably possesses a softening temperature of less than 100° C., more particularly less than 80° C.

In one particularly preferred embodiment in accordance with the invention, the polymeric film-former matrix used comprises Desmomelt 5300, which is available commercially from Bayer MaterialScience AG, 51358 Leverkusen, Germany. Desmomelt 530® is a hydroxyl-terminated, largely linear, thermoplastic, highly crystallizing polyurethane elastomer.

In accordance with the invention, the amount of the polymeric film-former matrix is in the range of about 20 to 80 wt %, preferably about 30 to 50 wt %, based on the total mixture of the constituents of the reactive film 30 of adhesive. Most preferred for use are 35 to 45 wt %, preferably about 40 wt %, of the polymeric film-former matrix, based on the total mixture of the constituents of the reactive film 30 of adhesive. The total mixture of the constituents of the reactive film 30 of adhesive here is the total amount of the polymeric film-former matrix (a) used, the reactive monomers or reactive resins (b), the reagent (c), and also further components, present optionally, that is obtained as the sum total (in wt %).

Reactive Monomer or Reactive Resin

As used herein, the reactive monomer or reactive resin is to be a monomer or resin capable in particular of a radical chain-growth polymerization. In accordance with the invention a suitable reactive monomer is selected from the group consisting of acrylic acid, acrylic esters, methacrylic acid, methacrylic esters, vinyl compounds and/or oligomeric and/or polymeric compounds having carbon-carbon double bonds.

Reactive monomers in one preferred embodiment are one or more representatives selected from the group consisting of the following: methyl methacrylate (CAS No. 80-62-6), methacrylic acid (CAS No. 79-41-4), cyclohexyl methacrylate (CAS No. 101-43-9), tetrahydrofurfuryl methacrylate (CAS No. 2455-24-5), 2-phenoxyethyl methacrylate (CAS No. 10595-06-9), di(ethylene glycol) methyl ether methacrylate (CAS No. 45103-58-0) and/or ethylene glycol dimethacrylate (CAS No. 97-90-5).

In a further preferred embodiment in accordance with the invention, the reactive film 30 of adhesive comprises a mixture of cyclohexyl methacrylate, tetrahydrofurfuryl methacrylate, methacrylic acid, and ethylene glycol dimethacrylate as reactive monomers for polymerization.

In a further preferred embodiment in accordance with the invention, the reactive film 30 of adhesive comprises a mixture of methyl methacrylate, methacrylic acid, and ethylene glycol dimethacrylate as reactive monomers for polymerization.

In a further preferred embodiment in accordance with the invention, the reactive film 30 of adhesive comprises a mixture of 2-phenoxyethyl methacrylate and ethylene glycol dimethacrylate as reactive monomers for polymerization.

In a further preferred embodiment in accordance with the invention, the reactive film 30 of adhesive comprises a mixture of di(ethylene glycol) methyl ether methacrylate and ethylene glycol dimethacrylate as reactive monomers for polymerization.

As reactive resin(s) it is possible to select oligomeric (meth)acrylates with mono-, di-, tri-, and higher functionalization. Very advantageously they are used in a mixture with at least one reactive monomer in the form of one or more monomers from the group consisting of acrylic acid, acrylic esters, methacrylic acid, methacrylic esters, and vinyl compounds.

Each of these preferred embodiments may in accordance with the invention be combined with a thermoplastic polyurethane, such as Desmomelt 530®, for example, as polymeric film-former matrix.

The amount of the reactive monomer/reactive monomers/reactive resin/reactive resins in accordance with the invention is in the range from about 20 to 80 wt %, preferably about 40 to 60 wt %, based on the total mixture of the constituents of the reactive film 30 of adhesive. Most preferred for use are about 40 to 50 wt % of the reactive monomer/reactive monomers/reactive resin/reactive resins, based on the total mixture of the constituents of the reactive film 30 of adhesive. The total mixture of the constituents of the reactive film 30 of adhesive here stands for the total amount of the polymeric film-former matrix (a) used, the reactive monomers or reactive resins (b), the reagent (c), and also further components, present optionally, that is obtained as the sum total (in wt %).

Activator

As used herein, the term “activator” stands for a compound which even at very low concentrations actually enables or accelerates the course of the polymerization. Activators may also be called accelerators.

In the present invention an activator is added to the film 7 of adhesive.

Suitable activators for use in the present invention, if a radically polymerizable system is to be activated, are selected, for example, from the group consisting of the following: an amine, a dihydropyridine derivative, a transition metal salt or a transition metal complex. In particular, tertiary amines are used for activating the radical-forming substance.

At least one of the catalytically active substances is selected from the group consisting of metal phthalocyanines and metal porphyrins. Advantageously all catalytically active substances used are selected from metal phthalocyanines and/or metal porphyrins.

Very preferably the metals of the metal phthalocyanines, where such complexes are used, are selected from the group consisting of iron, cobalt, copper, nickel, aluminum, magnesium, manganese, tin, and zinc.

Very preferably the metals of the metal porphyrins, where such complexes are used, are selected from the group consisting of iron, cobalt, copper, nickel, aluminum, magnesium, manganese, tin, and zinc.

In a very preferred procedure, iron(II) phthalocyanine [C32H16FeN8] (CAS No. 132-16-1) as catalytically active substance—in particular, exclusively, but possibly also in combination with one or more further metal phthalocyanines and/or one or more further metal porphyrins—is used as catalytically active substance. An advantageous combination of catalytically active substances is, for example, that composed of iron phthalocyanine and one or more iron porphyrins.

The catalytically active substance(s), such as iron(II) phthalocyanine, for example, is or are used preferably in an amount of up to two parts by weight per 100 parts by weight of reactive monomers, more preferably in an amount of 0.1 to 1 part by weight per 100 parts by weight of reactive monomers.

Crosslinker

As used herein, the term “crosslinker” stands for chemical compounds which are capable of providing linear molecular chains with reactive functional groups so as to allow three-dimensionally crosslinked structures to form from the two-dimensional structures, via the formation of intermolecular bridges.

Typical examples of crosslinkers are chemical compounds which within the molecule or at the two ends of the molecule have two or more identical or different functional groups, and consequently are able to crosslink molecules of the same or else different structures with one another. Moreover, a crosslinker is able to react with the reactive monomer or reactive resin, as defined above, without this reaction producing a polymerization in the true sense. The reason is that, unlike the activator, as described above, a crosslinker can be incorporated into the polymer network. In one advantageous procedure, the substances which are reactive in radical polymerization reactions are used in a film-former matrix, to result in a bonding agent comprising at least the matrix and the adhesive. The film-former matrix may be formed very advantageously by a polymer, and hence may take the form of a polymeric film-former matrix. Included in the matrix are the reactive monomers, the catalytically active substances, and also any further constituents of the adhesive. In one preferred embodiment in accordance with the invention, the matrix contains exclusively the reactive monomers and the catalytically active substance(s).

Further Constituents of the Reactive Film 30 of Adhesive

In order to stabilize the bond between the bonding systems of the invention and the adherend after the plasma activation and up to the development of the requisite bond strength, it may be advantageous to make the matrix pressure-sensitively adhesive, in other words such that the matrix itself has an inherent tackiness—particularly at room temperature. For this purpose it is possible to have recourse to the pressure-sensitive adhesive systems familiar to the skilled person—for instance, corresponding polyacrylates, silicones, and polyurethanes.

In one preferred embodiment in accordance with the invention, a thermoplastic polyurethane is used. The thermoplastic polyurethane preferably possesses a softening temperature of less than 100° C., more particularly less than 80° C.

The total mixture of the bonding agent here is the total amount of the film-former matrix used, the reactive monomers, the catalytically active substance. In a further advantageous procedure, the viscosity of the substances which are reactive in radical polymerization reactions is increased significantly using a thickener. In principle it is possible here to select all thickeners familiar to the skilled person, provided they are compatible with the polymeric matrix, the monomer, and the solvents. The amount of thickener used is dependent on its nature and may be selected by the skilled person in accordance with the desired degree of viscosity.

The adhesives of the present invention may optionally comprise further additives and/or auxiliaries which are known in the prior art. Deserving of mention here, for example, are fillers, dyes, nucleating agents, rheological additives, expandants, adhesion-boosting additives (adhesion promoters, tackifier resins), compounding agents, plasticizers and/or anti-aging agents, light stabilizers, and UV stabilizers, in the form for example of primary and secondary antioxidants.

It has proven very advantageous in accordance with the invention for the adhesives to be admixed with one or more substances capable of sorbing permeable substances—such as water vapor or oxygen. Such materials are referred to as getter materials or else, in abbreviated form, as getters. A getter material in the present specification, accordingly, is understood as a material which is able selectively to absorb at least one permeable substance. The getter material could therefore also be termed a “sorbent” or “sorption agent”. The getter material is preferably capable at least of sorbing water.

Through the addition of getters it has been possible to achieve a substantial reduction in the time taken for the adhesive to cure, without severely lowering the working time.

In accordance with their function, the getter materials are used preferably as materials substantially free from permeates, being water-free, for example. This distinguishes getter materials from similar materials which are used as a filler. For example, silica in the form of fumed silica is used frequently as a filler. If, however, this filler is stored in the usual way under ambient conditions, it already absorbs water from the environment and is no longer functional as a getter material to a technically utilizable extent. Only dried silica or silica which has been kept dry can be utilized as a getter material. In accordance with the invention, however, it is also possible to use materials which are already partly complexed with permeates, examples being CaSO₄*½H₂O (calcium sulfate hemihydrate) or partially hydrogenated silicas, which are present by definition as compounds of the general formula (SiO₂)ₘ*nH₂O.

Examples of getter materials are as follows: salts such as cobalt chloride, calcium chloride, calcium bromide, lithium chloride, lithium bromide, magnesium chloride, barium perchlorate, magnesium perchlorate, zinc chloride, zinc bromide, silicas (for example, silica gel), aluminum sulfate, calcium sulfate, copper sulfate, barium sulfate, magnesium sulfate, lithium sulfate, sodium sulfate, cobalt sulfate, titanium sulfate, sodium dithionite, sodium carbonate, sodium sulfate, potassium disulfite, potassium carbonate, magnesium carbonate, titanium dioxide, kieselguhr, zeolites, phyllosilicates such as montmorillonite and bentonite, metal oxides such as barium oxide, calcium oxide, iron oxide, magnesium oxide, sodium oxide, potassium oxide, strontium oxide, aluminum oxide (activated aluminum); additionally, carbon nanotubes, activated carbon, phosphorus pentoxide, and silanes; readily oxidizable metals such as, for example, iron, calcium, sodium, and magnesium; metal hydrides such as, for example, calcium hydride, barium hydride, strontium hydride, sodium hydride, and lithium aluminum hydride; hydroxides such as potassium hydroxide and sodium hydroxide, metal complexes such as, for example, aluminum acetylacetonate; furthermore, organic absorbers, examples being polyolefin copolymers, polyamide copolymers, PET copolyesters, anhydrides of monocarboxylic and polycarboxylic acids such as acetic anhydride, propionic anhydride, butyric anhydride or methyltetrahydrophthalic anhydride, isocyanates, or other absorbers based on hybrid polymers, used mostly in combination with catalysts such as cobalt, for example; further organic absorbers such as, for instance, weakly crosslinked polyacrylic acid, polyvinyl alcohol, ascorbates, glucose, gallic acid, or unsaturated fats and oils.

In accordance with the invention it is also possible to use mixtures of two or more getter materials.

Silicas, as described above, are compounds of the general formula (SiO₂)m*nH₂O. They comprise silicon dioxide prepared by wet-chemical, thermal or pyrogenic processes. Particularly suitable getter materials among the silicas are silica gels, examples being silica gels impregnated with cobalt compounds as a moisture indicator (blue gel), and fumed silicas. Of the SiO₂ compounds, furthermore, kieselguhr is suitable, but is not generally considered to be one of the silicas.

By “silanes” are meant compounds of the general formula Rₐ—Si—X₄₋ₐ or their partial condensation products. In the formula, a is an integer from 0 to 3 and is preferably 0 or 1. X is a hydrolysable group, as for example and preferably a halogen atom, more particularly chloro, an alkoxy group such as, for example, a methoxy, ethoxy, n-propoxy, isopropoxy, n-butoxy, sec-butoxy or tert-butoxy group, or an acetoxy group. Further examples of hydrolysable groups known to the skilled person can likewise be employed for the purposes of the present invention. Where there are two or more substituents X, they may be the same as or different from one another. R is an optionally substituted hydrocarbon radical. Where there are two or more substituents R, they may be identical to or different from one another.

“Carbodiimides” are compounds of the general formula R¹—N═C=N—R², where R¹ and R² are organic radicals, more particularly alkyl or aryl radicals, which may be identical or different.

The getter materials used are preferably selected from the group encompassing
cobalt chloride, calcium chloride, calcium bromide, lithium chloride, lithium bromide, magnesium chloride, barium perchlorate, magnesium perchlorate, zinc chloride, zinc bromide, aluminum sulfate, calcium sulfate, copper sulfate, barium sulfate, magnesium sulfate, lithium sulfate, sodium sulfate, cobalt sulfate, titanium sulfate, sodium carbonate, sodium sulfate, potassium carbonate, magnesium carbonate
kieselguhr, silicas, zeolites, phyllosilicates
iron, calcium, sodium, magnesium, barium oxide, calcium oxide, iron oxide, magnesium oxide, sodium oxide, titanium dioxide, potassium oxide, strontium oxide, activated aluminum oxide
carbon nanotubes, activated carbon, phosphorus pentoxide, silanes
calcium hydride, barium hydride, strontium hydride, sodium hydride, and lithium aluminum hydride, potassium hydroxide, sodium hydroxide, and aluminum acetyl acetonate
polyolefin copolymers, polyamide copolymers, PET copolyesters,
acetic anhydride, propionic anhydride, butyric anhydride, methyltetrahydrophthalic anhydride,
polyacrylic acid and polyvinyl alcohol,
   since these materials are very suitable as water getters.

With very particular preference the getter materials used are selected from calcium oxide, calcium sulfate, calcium chloride, and zeolites, and also from mixtures of two or more of the above substances. These materials have particularly high capacities for the absorption of water and other permeates, are very largely regenerable, can be incorporated outstandingly into the adhesive, and have only a negligible adverse effect, or none at all, on the function of this layer in the amount according to the invention.

The fraction of the getter materials in the adhesive is advantageously not more than 5 wt %, preferably not more than 1 wt %.

Alternatively or additionally thereto, the matrix may also comprise getter materials, very preferably one or more of the aforementioned getters.

Plasma, Initiator

Exposure of the bonding agent to a plasma in the presence of the catalytically active substance initiates the polymerization reaction of the reactive monomers, leading to curing of the adhesive composition and so to the production of the adhesively bonded assembly. A plasma is a gas whose molecules, completely or partly, are in ionized form. The ionization takes place under the influence of electrical fields, and one of its results is the formation of radicals (in particular through fragmentation of gas molecules). As well as chemical species, various radiation components (e.g., VUV, UV, visible, IR) may also be formed.

Plasma generation may in accordance with the invention take place in principle with all common plasma sources. Preferred in accordance with the invention is the use of methods such as dielectric barrier discharge (DBD), corona discharge, or the generation of driven plasmas. Excitation by microwaves can also be used in numerous cases.

A driven plasma is understood to refer to any systems wherein the plasma is driven out by a stream of gas from the electrode geometry in which it is generated. Such methods are known by the name—among others—of PlasmaJet®, Plasma-Pen®, plasma blaster, corona gun (as a driven corona), to name only a few, without limitation.

In principle it is possible to use low-pressure plasmas, atmospheric pressure plasmas (standard pressure plasmas), and high-pressure plasmas. There is an advantage in operating at a pressure in the range between 500 and 1200 hPa, more preferably at atmospheric pressure. In the case of atmospheric pressure plasma, the pressure corresponds essentially to that of the surrounding atmosphere, unless apparatus is used to raise or lower it, and the pressure therefore, depending on climatic conditions, is customarily approximately in the region of 1013±60 hPa (at sea level; standard pressure=1013.25 hPa).

In the case of low-pressure plasmas, care should advantageously be taken to ensure that the monomers, which are frequently in liquid form, do not boil. Typical industrial low-pressure plasmas are operated in the pressure range of a few (up to several hundred) pascals, in other words at pressures which are lower by a factor of 100 to 10 000 than the standard atmospheric pressure.

Depending on source and plasma generation conditions, a distance of a few tenths of millimeters up to several centimeters is selected between the bonding agent composition to be plasma-treated—or, to be more exact, the surface thereof—and the plasma source, or the bonding agent composition runs through the electrode arrangement of the plasma source.

Process gases used for plasma treatment may be the usual process gases. With particular advantage it is possible to use oxygen-containing process gases, such as, for example, (pure) oxygen, air, steam, or mixtures of two or more of the aforementioned gases, and/or mixtures with other gases, such as, for instance, nitrogen, noble gases (such as argon), and the like. Employed with particular advantage are humid gases (that is, gas mixtures containing water vapor).

The plasma treatment ought preferably to be conducted such that the process gas does not heat to more than 120° C., preferably not more than 60° C., in order not to stress the adhesive system and/or the substrates to be bonded. This may be achieved in particular by conducting plasma generation in such a way that the electrodes do not heat up above these temperatures.

The duration of the plasma treatment for efficient initiation of the polymerization reaction is generally a few seconds, as for example up to 60 seconds. A plasma treatment time of the surface for a duration of up to 15 seconds, more particularly from 3 to 10 seconds, has proven very favorable in order to ensure optimum strength of the adhesive bond.

There are a variety of plasma generators on the market, differing in the technology for plasma generation and in the gas atmosphere. Although the treatments differ in factors including the efficiency, the fundamental effects are usually similar and are determined in particular by the gas atmosphere employed. In accordance with the invention there is in principle no restriction on the choice of plasma generators, provided the aforementioned conditions can be realized.

In principle it is also possible to admix the atmosphere with reactive gaseous species such as oxygen, hydrogen, ammonia, ethylene, CO₂, siloxanes, acrylic acids and/or solvents, and also coating or polymerizing constituents.

In order to maximize bond strengths, the polymerization reaction is taken to substantially full conversion rates of the reactive monomers. By way of the time and the intensity of the plasma treatment and/or by way of the amount of catalyst used, however, the method of the invention also opens up the possibility for the ultimate bond strength to be varied and adjusted to desired levels.

The amount of thickener in the adhesive is preferably such that the adhesive takes the form of a bonding agent layer; the bonding agent layer is provided on the liner for greater durability.

The folding device may likewise comprise two or more individual folding devices, so that the applicator is hand-guidable; modern plasma sources may have a weight of a few kilograms, and so the applicator may well have a weight of only between 5 kg and 20 kg, hence may well also be secured with carrying straps or simply carried by the user by the handle, and so the adhesive tape is applied to the adherend surface.

Particularly preferred for use are dielectric barrier discharges, plasma nozzle systems or corona systems, whose process gas is air, nitrogen, noble gases or steam; these are inexpensive and easily producible. The process gas may preferably be admixed with reactive species, such as oxygen, hydrogen, ammonia, ethylene, carbon dioxide, siloxanes, acrylic acid, peroxides and/or solvents. The reactive species of the process gas are suitable in particular in interaction with an adhesive tape comprising a bonding agent which comprises a catalytically active substance and at least one substance reactive in a radical polymerization reaction, where the catalytically active substance comprises at least one metal complex from the group of the metal oxtanins or the group of the metal porfyrins.

In the method for producing a folded adhesive tape from an adhesive tape, an adhesive tape comprising a bonding agent layer is unwound from an adhesive tape roll, a reactive outer side of the bonding agent layer of the adhesive tape is conveyed past or through a plasma source which is operated with a process gas enriched with reactive species, the bonding agent layer being provided with at least one substance which triggers a crosslinking reaction initiated by the reactive species, and the adhesive tape is folded, so that the folded adhesive tape has a thickness corresponding to an integral number of adhesive layers folded one over another. At each folding, the adhesive tape is folded along a fold line running in the longitudinal direction; after or before each folding operation, liner remnants may be stripped from the folded adhesive tape by means of a stripping device.

In one preferred embodiment of the invention; the film 30 of adhesive comprises a mixture of the following constituents: thermoplastic polyurethane, especially Desmomelt 530®, cyclohexyl methacrylate, tetrahydrofurfuryl methacrylate, methacrylic acid, ethylene glycol dimethacrylate, and PDHP.

In a further preferred embodiment of the invention, the film 30 of adhesive comprises a mixture of the following constituents: thermoplastic polyurethane, especially Desmomelt 530®, methyl methacrylate, methacrylic acid, ethylene glycol dimethacrylate, and PDHP.

In a further preferred embodiment of the invention, the film 30 of adhesive comprises a mixture of the following constituents: thermoplastic polyurethane, especially Desmomelt 530®, 2-phenoxyethyl methacrylate, ethylene glycol dimethacrylate, and PDHP.

In a further preferred embodiment of the invention, the film 30 of adhesive comprises a mixture of the following constituents: thermoplastic polyurethane, especially Desmomelt 530®, di(ethylene glycol)methyl ether methacrylate, ethylene glycol dimethacrylate, and PDHP.

Each of these preferred embodiments of the invention contains about 20 to 80 wt % of thermoplastic polyurethane, about 20 to 80 wt % of reactive monomer(s), and greater than 0 to about 40 wt % of PDHP, preferably about 30 to 50 wt % of thermoplastic polyurethane, about 40 to 60 wt % of reactive monomer(s), and about 15 to 25 wt % of PDHP, based on the total mixture of the constituents of the reactive film 30 of adhesive.

As used here, the total mixture of the constituents of the reactive film 30 of adhesive relates to the total amount of the polymeric film-former matrix used, of the reactive monomer/monomers and or of the reactive resin/resins, the reagent, and also further components, present optionally, which is obtained as the sum total (in wt %).

The invention is described with reference to a working example in six figures, wherein

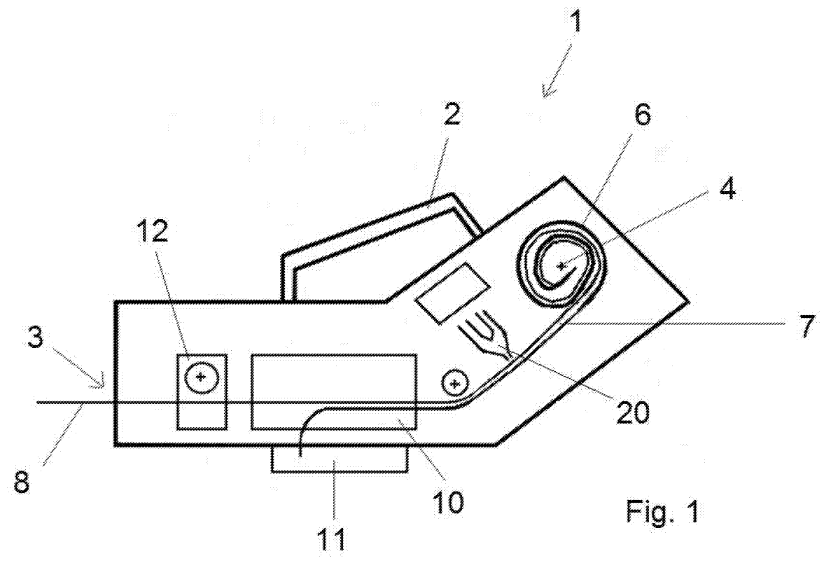

FIG. 1 shows a hand-guided applicator in a schematic interior view,

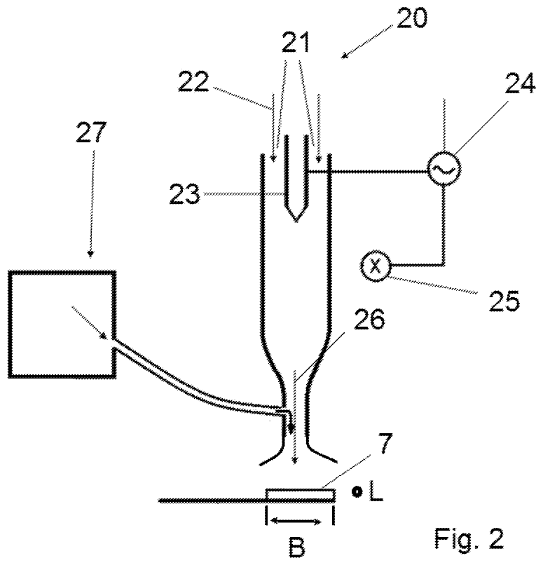

FIG. 2 shows plasma source with feed apparatus for defined process gas constituents,

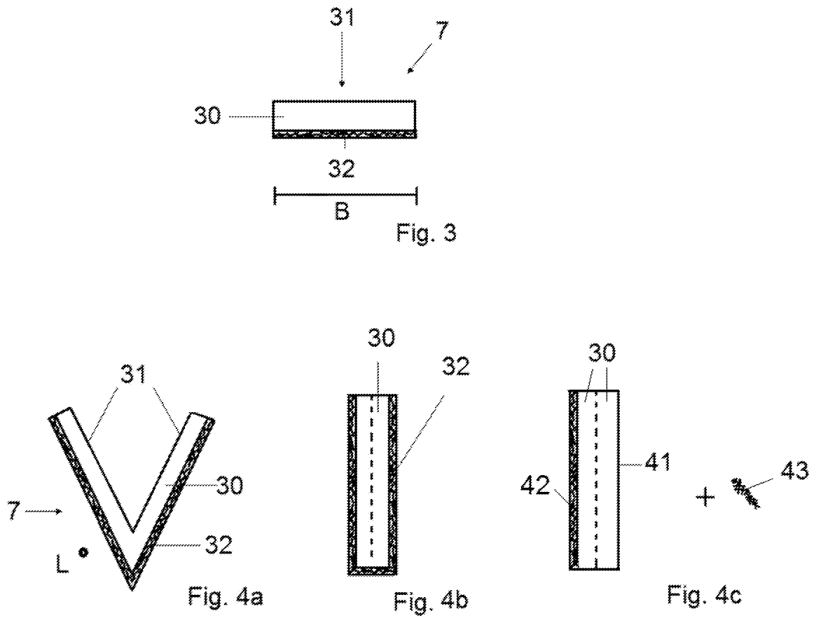

FIG. 3 shows a sectional view of an adhesive tape as used in an applicator in FIG. 1,

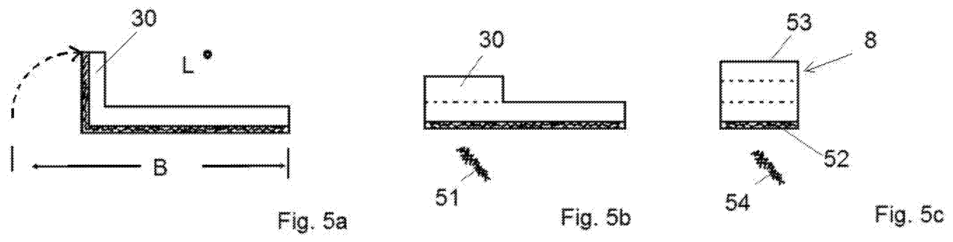

FIGS. 4a to 4c show method steps in an uneven-numbered folding of the adhesive tape,

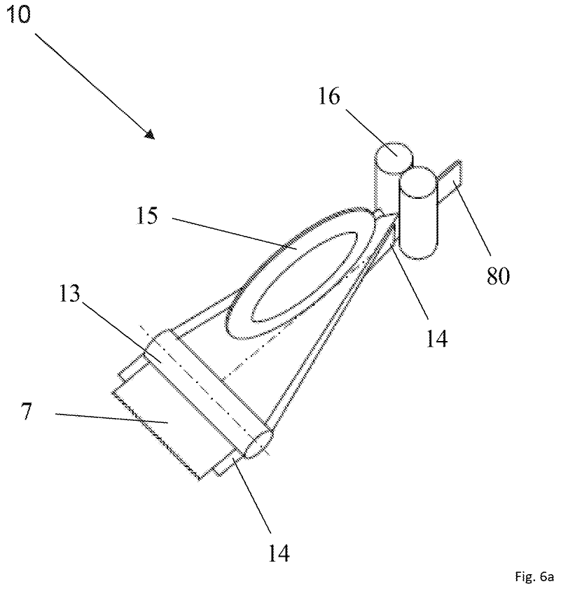

FIGS. 5a to 5c show method steps in an even-numbered folding of the adhesive tape,

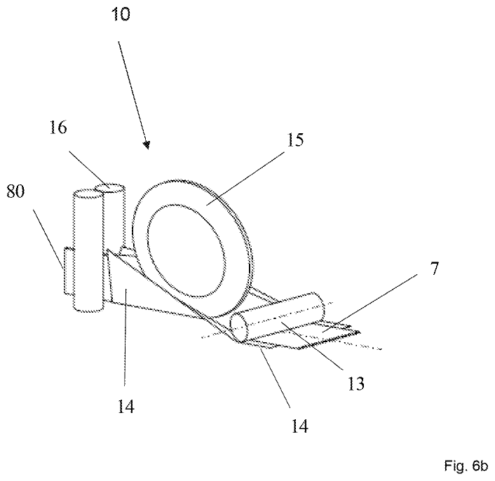

FIGS. 6a, 6b show the folding mechanism.

A hand-guided applicator 1 in a first embodiment, shown in FIG. 1, has a housing which comprises two sections arranged at an angle to one another, and a handle 2, which is mounted by respective ends on one of the two sections and can be used by a person to carry the applicator 1.

Shown in an interior view in FIG. 1 are the essential components of the applicator 1. At one end of the applicator 1 there is an adhesive tape exit 3, from which a singly or multiply folded adhesive tape 8 runs out, and can be applied, i.e., bonded, by means of the applicator 1 to a surface of an adherend (not shown). The adhesive tape 7 is folded once, twice or more times by means of a folding device 10. The folded adhesive tape 8 is folded as many times as required to take on a predetermined thickness. At an end opposite from the adhesive tape exit 3, there is a holder 4 for an adhesive tape roll 6. The adhesive tape 7 is wound on the adhesive tape roll 6. In a running direction of the folded adhesive tape 8 upstream of the adhesive tape exit 3, there is a cutting device 12 which cuts the folded adhesive tape 8 to the desired length.

A free end of the adhesive tape 7 is passed through an unwind device (not shown in more detail). An end section departing from the adhesive tape roll 6 is drawn off continually by the unwind device from the adhesive tape roll 6.

The folded adhesive tape 8 is produced from the adhesive tape 7 wound on the adhesive tape roll 6. A folded adhesive tape 8 here means an adhesive tape having a greater thickness than the adhesive tape 7.

Shown schematically in FIG. 2 is a plasma source 20 as used in the applicator 1 as per FIG. 1.

FIG. 2 shows the adhesive tape 7; the plasma source 20 has a breadth B corresponding substantially to the breadth B of the adhesive tape 7; the direction of movement of the adhesive tape is in FIG. 2 perpendicular to the plane of the drawing, in other words in longitudinal direction L; the adhesive tape 7 is drawn through out of the drawing, as it were, upward below the plasma source 20. The adhesive tape 7 has the free, activatable adhesive tape side 31 facing the plasma source 20, and the adhesive tape side lined with the liner 32 facing away from the plasma source 20.

With the aid of the plasma source 20, a crosslinking procedure is initiated in an adhesive of the adhesive layer 30 of the adhesive tape 7; while the adhesive layer 30 is pressure-sensitively adhesive, polymers in the adhesive layer 30 are nevertheless not fully crosslinked, and so the adhesive layer 30 is not fully cured and is also not able to develop a permanent bond to the surface of an adherend. The crosslinking operation is initiated by treatment with a plasma matched to the adhesive; in terms of its duration, the crosslinking procedure is tailored so that the folded adhesive tape can also still be applied to the adherend after folding.

The plasma source 20 has an entry 21 for a process gas 22. The process gas here is air or steam, although it is also possible for nitrogen, noble gases or a mixture of the stated species to be used. The process gas 22 is conveyed past an electrode tip 23; the electrode tip 23 is connected to a high-frequency AC voltage 24 of several kV and a frequency of about 50 Hz to 50 kHz. A strong electrical alternating field comes about between the electrode 23 and a counterelectrode 25, and leads to a discharge. The process gas 22 flowing past the electrodes 23 and 25 is ionized and forms the typical plasma atmosphere 26 being dependent on the process gas and on the discharge parameters. From the precursor unit 27, the plasma atmosphere 26 is admixed with reactive species, such as oxygen, hydrogen, ammonia, ethylene, carbon dioxide, siloxanes, acrylic acid, peroxides and/or solvents. The reactive species are tailored to the adhesive of the adhesive layer 30 of the adhesive tape 7. The precursor-enriched plasma impinges on the activatable, free adhesive tape side 31, where it initiates a chain-linking process in the adhesive layer 30.

The adhesive tape 7, shown perpendicular to its longitudinal direction L in the cross section in FIG. 3, is first wound on the adhesive tape roll 6; the adhesive tape 7 comprises a film 30 of adhesive having a free, reactive outer side 31 and a liner 32, which is disposed on the film 30 of adhesive along a side opposite the free, reactive outer side 31. The free, reactive outer side 31 of the film 30 of adhesive is pressure-sensitively adhesive.

Before the folding operation or between individual folding operations, it is also possible for the liner 32, or at least sections of the liner 32, to be removed from the adhesive tape 7. Adjacent to the folding device 10 there is a storage container 11 for liner remnants 43, 51, 54 of the liner 32.

After the single or multiple folding operation, a folded adhesive tape 8 departs the folding device 10; on an outer side, the folded adhesive tape 8 continues to be protected by part of the liner left over after the folding operation and separating operation of the liner part, while an outer side opposite the leftover liner part remains activated. The thickness of the folded adhesive tape 8 that has come about by folding corresponds to twice, three times, four times or any higher integral number of thicknesses of the adhesive tape 7. The folded adhesive tape 8 departs the application exit with a leftover liner 42.

FIG. 3 shows the adhesive tape 7 in a single embodiment in a cross section along the breadth B of the adhesive tape 7. The adhesive tape 7 comprises an adhesive layer 30 and a liner which is thinner by comparison with the thickness of the bonding agent layer 30; adhesive layer 30 and liner 32 have an identical breadth B, and so one side of the adhesive layer 30 is completely hidden by the liner 32, while an outer side 31 of the adhesive layer 30, opposite the liner 32, is free.

The sequence of FIGS. 4a, 4b, 4c shows a single folding of the adhesive tape 7, whereas the folding shown in FIGS. 5a, 5b, 5c represents a double folding of the adhesive tape along, respectively, one or two fold lines running in the longitudinal direction L.

The folding in the sequence of the figure series 4a, 4b, 4c takes place along an individual fold line, which runs centrally in the longitudinal direction L along the adhesive tape 7. Along the fold line, the free outer side 31 of the adhesive layer 30 is folded onto one another, with two parallel longitudinal strips of the outer face 31 being folded on one another and bonding to one another. An intermediate position during the folding operation is shown in FIG. 4a. FIG. 4b shows the condition in which the adhesive tape 7 is fully folded. After the single folding, the liner 32 surrounds the singly folded bonding agent layer 30 in a U-shape, The folding device 10 likewise comprises a cutting device (not shown), with which a liner remnant 43, L-shaped in cross section perpendicular to the longitudinal direction L, is removed from the singly folded adhesive tape 7, and a leftover liner 42 remains on the folded bonding agent layer 30, thus producing a singly folded adhesive tape 8 as per FIG. 4c which departs the applicator 1 at the exit 3. On one side the singly folded adhesive tape 8 has a leftover liner 42, whereas the side 41 of the doubled adhesive layer 30, opposite the leftover liner 42, is free. In other embodiments of the invention it is conceivable for the folded adhesive tape to be activated once again with a further plasma source (not shown). In that case the activation would be on the newly formed free outer side 41 of the folded adhesive tape.

Shown in FIGS. 5a, 5b is a double folding; the double folding likewise starts from the adhesive tape 7 as per FIG. 3, with the adhesive tape 7 taking place not in the longitudinal direction L centrally, but instead along a fold line which runs in the longitudinal direction L in a third of the breadth B. The beginning of the first folding is shown in FIG. 5a; FIG. 5b shows the fully folded-round adhesive layer 30, from which a cross-sectionally L-shaped liner remnant 51 has already been removed. In a second folding, a third third of the adhesive tape 7 is folded over the already folded section of the adhesive tape 7, as shown by the arrow depicted in FIG. 5b, to form a doubly folded adhesive tape 8, which is composed of three adhesive layers 30 layered one on top of another. Arranged on an outer side of the folded bonding agent layers 30 is a leftover liner 52, and a free outer side 53 remains on the side opposite the leftover liner 52. After the second folding, again, a liner remnant 54 is separated off using the cutting device.

Depending on the number of folds, therefore, folded adhesive tapes 8 may be produced in desired, predetermined thickness.

The film 30 of adhesive here comprises a polymeric film former matrix, at least one reactive monomer or reactive resin, and at least one initiator, more particularly radical initiator. The film 30 of adhesive of the invention consists fundamentally of a matrix, referred to hereinafter as polymeric film-former matrix, which comprises the reactive monomers for polymerization and/or reactive resins. The function of this matrix is to form an inert scaffold for the reactive monomers and/or reactive resins, so that these monomers/resins are not in liquid form, but are instead incorporated in a film or a sheet. In this way, ease of handling is ensured.

Inert in this context means that the reactive monomers and/or reactive resins, under appropriately selected conditions (for example, at sufficiently low temperatures), undergo substantially no reaction with the polymeric film-former matrix.

Shown in FIG. 6a, 6b is the folding mechanism 10 from which the adhesive tape 80, consisting of a first adhesive tape 7 and a plasma initiation, is supplied. By means of a pressing roller 13 and a contour wheel 15, the adhesive tape 80 is pressed into a guide rail 14 as it moves in the longitudinal direction L. The guide rail 14 has a changing angle in respect of its center line in the longitudinal direction L. This angle, starting from the entry point into the folding mechanism 10, is brought continuously from an opening angle of 180° to less than 20°, before the adhesive tape reaches the laminating rollers 16 and the folded adhesive tape 8 is formed. Below the contour wheel there may be a cutting element, which severs liner 32 and/or the adhesive tape 80 along the fold line.

### LIST OF REFERENCE SYMBOLS

1 applicator
2 handle
3 adhesive tape exit
4 holder
6 adhesive tape roll
7 adhesive tape
8 adhesive tape
9 deflection roll
10 folding device
11 storage container
12 cutting device
20 plasma source
21 entrance
22 process gas
23 electrode tip
24 high-frequency AC voltage
25 counterelectrode
26 plasma atmosphere
27 precursor unit
30 bonding agent layer
31 outer side
32 liner
B breadth
L longitudinal direction
41 opposite side
42 leftover liner
43 liner remnant
51 L-shaped liner remnant
52 liner
53 free outer side
54 liner remnant

1. An applicator for a folded adhesive tape, the applicator comprising:
an adhesive tape roll with an adhesive tape,
the adhesive tape comprising a bonding agent layer having a reactive adhesive component and a reactive outer side,
an unwinding device for the adhesive tape, configured to unwind an end section of the adhesive tape from the adhesive tape roll,
a feed device comprising a plasma source having a process gas enriched with reactive species; wherein the feed device is configured to direct the reactive species onto a reactive outer side of the bonding agent layer of the unwound end section of the adhesive tape, wherein the bonding agent layer comprises at least one substance which triggers a crosslinking reaction initiated by the reactive species, and
a folding device for the adhesive tape, disposed downstream of the plasma source in a running direction of the activated adhesive tape, for producing the folded adhesive tape.

2. The applicator of claim 1,
wherein the folding device further comprises a stripping device for a liner disposed on the side of the adhesive tape opposite the reactive outer face.

3. The applicator of claim 1,
wherein the process gas comprises air, nitrogen, a noble gases, steam, or any combination thereof.

4. The applicator of claim 1,
wherein the the process gas comprises at least one added reactive species selected from the group consisting of oxygen, hydrogen, ammonia, ethylene, carbon dioxide, siloxanes, acrylic acid, peroxides, solvents, and any combination thereof.

5. The applicator of claim 1,
wherein the bonding agent layer comprises a bonding agent which comprises a catalytically active substance and at least one substance reactive in a radical polymerization reaction.

6. The applicator of claim 5,
wherein the reactive substance comprises at least one species selected from the group consisting of acrylic acid, acrylic esters, methacrylic acid, methacrylic esters, vinyl compounds having carbon-carbon double bonds, oligomeric compounds having carbon-carbon double bonds, polymeric compounds having carbon-carbon double bonds, and any combinations thereof.

7. The applicator of claim 5,
wherein the catalytically active substance comprises at least one metal complex from the group of the metal phthalocyanines and/or the group of the metal porphyrins.

8. The applicator of claim 1,
wherein the applicator comprises a handle and is hand-guidable.

9. A method for producing a folded adhesive tape from an adhesive tape, the method comprising:
unwinding the adhesive tape, wherein the adhesive tape comprises a bonding agent layer from an adhesive tape roll,
conveying a reactive outer side of the bonding agent layer of the adhesive tape past a plasma source which is operated with a process gas enriched with reactive species, wherein the bonding agent layer is provided with at least one substance which triggers a crosslinking reaction initiated by the reactive species, and
folding the adhesive tape.

10. The method of claim 9,
wherein the adhesive tape is folded along a fold line running in a longitudinal direction.

11. The method of claim 9,
wherein the process gas comprises air, nitrogen, a noble gase, steam, or any combination thereof.

12. The method of claim 9,
wherein the reactive species added comprises at least one reactive species selected from the group consisting of oxygen, hydrogen, ammonia, ethylene, carbon dioxide, siloxanes, acrylic acid, peroxides, solvents, and any combination thereof.

13. The method of claim 9,
wherein the bonding agent is admixed with a catalytically active substance and a substance reactive in a radical polymerization reaction.

14. The method of claim 13,
wherein the catalytically active substance comprises at least one metal complex from the group of the metal phthalocyanines and/or the group of the metal porphyrins.

15. The method of claim 13,
wherein the reactive substance is selected from the following group: acrylic acid, acrylic esters, methacrylic acid, methacrylic esters, vinyl compounds and/or oligomeric and/or polymeric compounds having carbon-carbon double bonds.
